(19) United States
(12) Patent Application Publication
(10) Pub. No.: US 2014/0172124 A1
(43) Pub. Date: Jun. 19, 2014

(54) Method and Device for Monitoring Signal Levels

(71) Applicant: ROBERT BOSCH GMBH, Stuttgart (DE)

(72) Inventors: Robert Kern, Sinzheim (DE); Tobias Kiefer, Rheinmuenster (DE)

(73) Assignee: ROBERT BOSCH GMBH, Stuttgart (DE)

(21) Appl. No.: 14/105,464

(22) Filed: Dec. 13, 2013

(30) Foreign Application Priority Data
Dec. 18, 2012 (DE) 10 2012 223 573.6

(51) Int. Cl. G05B 15/02

(52) U.S. Cl. CPC G05B 15/02
USPC 700/19

(57) ABSTRACT

A method for monitoring the signal levels of signals that are generated, for the purpose of detecting a magnetic field, by a plurality of Hall sensors, includes determining an average value of the signal levels. The method further includes comparing a progression of the average value with an expected progression of the average value. The expected progression includes a characteristic temporal sequence of a first value and at least a second value that differs from the first value. An error message is provided if the average value deviates from the expected progression by more than a tolerance range.

This application claims priority under 35 U.S.C. §119 to patent application no. DE 10 2012 223 573.6, filed on Dec. 18, 2012 in Germany, the disclosure of which is incorporated herein by reference in its entirety.

### BACKGROUND

The present disclosure relates to a method for monitoring signal levels, to a device for monitoring signal levels, and also to a corresponding computer program product.

A position of a magnetic field of a rotor can be taken into consideration in order to control the process of electronically commutating a DC motor. At least one Hall sensor can be used for determining the position.

DE 10 2007 031 385 A1 describes a method and a device for detecting a low voltage supply at least of one Hall sensor.

### SUMMARY

On the basis of this background, the present disclosure discloses a method for monitoring signal levels of signals that are generated, for the purpose of detecting a magnetic field, by means of Hall sensors, the disclosure further discloses a device for monitoring signal levels that are generated, for the purpose of detecting a magnetic field, by Hall sensors and finally the disclosure discloses a corresponding computer program product in accordance with the independent claims. Advantageous embodiments are evident from the respective dependent claims and the description hereinunder.

In addition to monitoring a supply voltage of the Hall sensors, it is possible by forming an average value of the signals of several Hall sensors using electrical resistors to detect malfunctions in the connection lines. A malfunction site can be detected by means of comparing an expected progression of the average value with an actual progression.

The disclosure discloses a method for monitoring signal levels of signals that are generated, for the purpose of detecting a magnetic field, by means of Hall sensors, wherein the method comprises the following steps:
(i) determining an average value of the signal levels; and
(ii) comparing a progression of the average value with an expected progression of the average value, wherein the expected progression comprises a characteristic temporal sequence of a first value and at least a second value that differs from the first value, wherein an error message is provided if the average value deviates from the expected progression by more than a tolerance range.

Furthermore, the disclosure discloses a device for monitoring signal levels of signals that are generated, for the purpose of detecting a magnetic field, by means of Hall sensors, wherein the device comprises the following features:
(i) a device unit for determining an average value of the signal levels; and
(ii) a device unit for comparing a progression of the average value with an expected progression of the average value, wherein the expected progression comprises a characteristic temporal sequence of a first value and at least a second value that differs from the first value, wherein the device is embodied for the purpose of providing an error message if the average value deviates from the expected progression by more than a tolerance range.

The object of the disclosure can also be achieved in a rapid and efficient manner by means of this design variant of the disclosure in the form of a device.

The term ‘signal level’ can be understood to mean an electric variable, by way of example an electric voltage. The signal level can result from a sensor detecting a change in a variable that is to be measured and said signal level can be ascertained in the signal line. The signal level can be dependent upon a supply voltage. The term “signal from a Hall sensor” can be understood to mean information regarding the strength of a magnetic flux of a magnetic field at the Hall sensor. The signal can be in an analog format or a binary format. If the signal is in a binary format, the signal can indicate whether the magnetic flux at the Hall sensor is greater or less than a threshold value. In order to form an average value of the signal levels, the signal levels can be directed by way of a respective electrical resistor and can be captured at a common point. The resistors can be identical for each of the signal levels. By way of example, a line resistance between the common point and the Hall sensors can also be of equal magnitude in each case. An expected progression can be an ideal progression. A tolerance range can represent a tolerable deviation of the signal level of the average value from the ideal progression. The expected progression can be stored in a memory device. Moreover, the tolerance range can be a tolerable temporal deviation of the average value from the ideal progression.

The term ‘device’ can be understood in this case to mean an electrical device that processes sensor signals and outputs control signals and/or data signals in dependence thereon. The device can comprise an interface that can be embodied in the form of hardware and/or software. In the case of interfaces in the form of hardware, the interfaces can be by way of example part of a so-called system—ASIC that includes the most varied functions of the devices. However, it is also possible that the interfaces are dedicated, integrated switching networks or are embodied at least in part from discrete components. In the case of interfaces in the form of software, the interfaces can be software modules that are provided in addition to other software modules by way of example on a microcontroller.

The error message can be provided if in the case of a transition between the values the average value dwells longer than a predetermined transition time outside a first tolerance range around the first value or outside a second tolerance range around the second value. The first tolerance range and the second tolerance range can be separated by a transition range. A predetermined transition time can be a transient recovery time that can occur in response to a change at least of one of the signal levels. By way of example, the average value can comprise an overshoot in the case of the transition between the values, which overshoot can be tolerable. The average value can likewise comprise an asymptotic approximation to the other value in the case of transition. In both cases, a tolerable time passes prior to the error message being provided.

The error message can be provided if the average value dwells longer than the transition time outside the first tolerance range or outside the second tolerance range or at least outside an additional tolerance range, wherein the additional tolerance range is arranged adjacent to the first tolerance range and/or the second tolerance range. The average value can by way of example comprise three stable values in the case of an even number of signals, which stable values each comprise a tolerance range. In the case of three signals, six discrete values of the average value can result as a result of using three resistors of different sizes in the lines to the Hall sensors, which discrete values can be monitored by means of the disclosed method. The tolerance ranges can be separated by means at least of an additional transition range and/or the transition range from the first tolerance range and/or the second tolerance range. The first tolerance range can be separated by a first blocking region from a minimum value of the average value. The second tolerance range can be separated by a second blocking region from a maximum value of the average value. The error message can be provided if the average value dwells longer than the transition time in the first blocking region or second blocking region.

The error message can include additional information that indicates from which tolerance range the average value deviates. As an alternative or in addition thereto, the error message can include additional information as to whether the average value dwells adjacent to a rising signal edge or adjacent to a falling signal edge. As a result of the content of detailed information, it is possible on the basis of the error message to locate a fundamental malfunction, by way of example, of the Hall sensors, in the signal lines and/or in the voltage supply more rapidly than in the case of a non-differentiated error message.

In the comparing step, position information regarding the magnetic field that is monitored by the Hall sensors is obtained from the average value, wherein the position information is determined from a correlation between an actual signal level of the average value and an angular position of the magnetic field. The expected progression can represent the correlation. The expected progression can be determined by way of example by recording the average value and the actual angular position of the magnetic field under controlled conditions. The expected progression can also be determined using a processing specification.

The average value can be determined from a first signal level, a second signal level and a third signal level. An angular resolution of 60° can be achieved in an electric motor using three Hall sensors if the Hall sensors are angularly displaced by 120° with respect to one another. When a function is performed correctly, the average value can comprise all the components of a regular progression that changes between a value of a third of a supply voltage of the Hall sensors and two thirds of the supply voltage.

Moreover, the average value can be determined from at least one additional signal level. As a result of additional Hall sensors, it is possible to achieve a higher level of angular resolution than in the case of three Hall sensors. By way of example, an angular resolution of 36° can be achieved using five Hall sensors that are arranged at regular intervals around the magnetic field.

The disclosure also advantageously discloses a computer program product having program code that can be saved to a machine-readable medium such as a semiconductor memory, a hard-disk storage device or an optical storage device and if the program product is implemented on a computer or a device said computer program is used to perform the method in accordance with one of the previously described embodiments.

### BRIEF DESCRIPTION OF THE DRAWINGS

The disclosure is further described hereinunder in an exemplary manner with reference to the attached drawings. In the drawings:

FIG. 1 illustrates a block diagram of a device for monitoring signal levels in accordance with an exemplary embodiment of the present disclosure;

FIG. 2 illustrates a flow diagram of a method for monitoring signal levels in accordance with an exemplary embodiment of the present disclosure;

FIG. 3 is a representation of an electric motor with a connected device for monitoring signal levels in accordance with an exemplary embodiment of the present disclosure; and

FIG. 4 is a representation of signals of Hall sensors and a resulting average value in accordance with an exemplary embodiment of the present disclosure.

### DETAILED DESCRIPTION

In the description hereinunder of preferred exemplary embodiments of the present disclosure, like or similar reference numerals are used for elements that are illustrated in the different figures and function in a similar manner, wherein the description of these elements is not repeated.

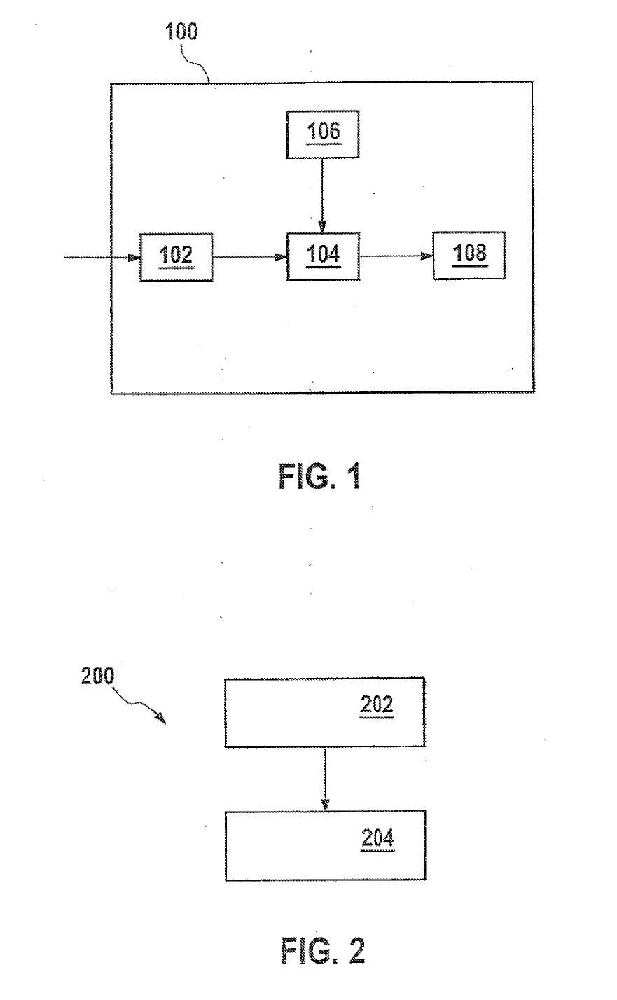

FIG. 1 illustrates a block diagram of a device 100 for monitoring signal levels in accordance with an exemplary embodiment of the present disclosure. The signal levels can be generated, for the purpose of detecting a magnetic field, by means of a plurality of Hall sensors. The device comprises a device unit 102 for the determining step and comprises a device unit 104 for the comparing step. The device unit 102 for the determining step is embodied for the purpose of determining an average value of the signal levels. The device unit 104 for the comparing step is embodied for the purpose of comparing a progression of the average value with an expected progression 106 of the average value. The expected progression 106 comprises a characteristic temporal sequence of a first value and at least a second value that differs from the first value. The device unit 104 is embodied for the purpose of providing an error message 108 if the average value deviates from the expected progression 106 by more than a tolerance range.

FIG. 2 illustrates a flow diagram of a method 200 for monitoring signal levels in accordance with an exemplary embodiment of the present disclosure. The method 200 is used to monitor signal levels of signals that are generated, for the purpose of detecting a magnetic field, by means of Hall sensors. The method 200 comprises a determining step 202 and a comparing step 204. In the determining step 202, an average value of the signal levels is determined. In the comparing step 204, a progression of the average value is compared with an expected progression of the average value. The expected progression comprises a characteristic temporal sequence of a first value and at least a second value that differs from the first value. An error message is provided if the average value deviates from the expected progression by more than a tolerance range.

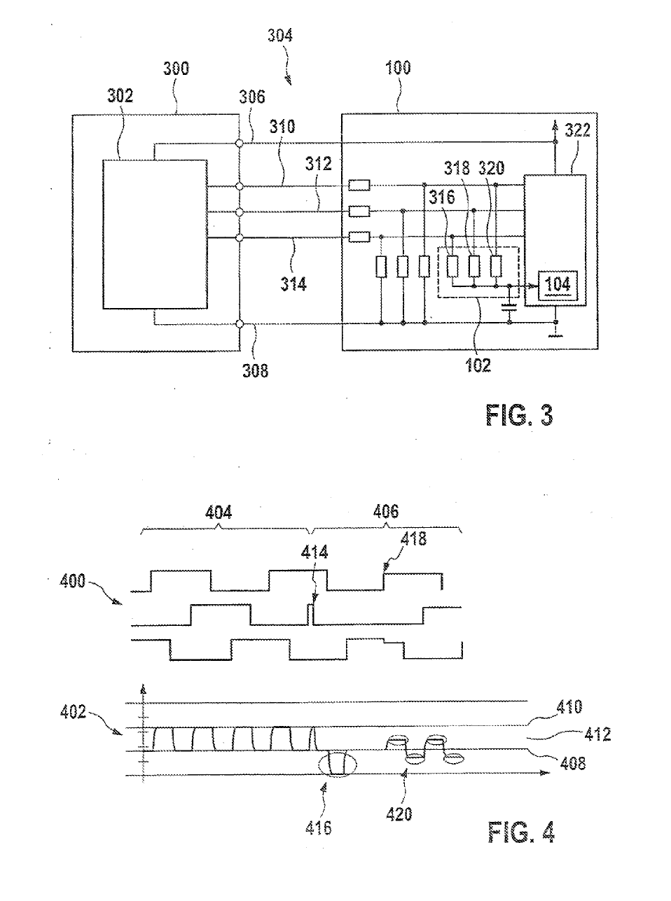

FIG. 3 is a representation of an electric motor 300 with a connected device 100 for monitoring signal levels in accordance with an exemplary embodiment of the present disclosure. The device 100 corresponds to the device for monitoring signal levels, as illustrated in FIG. 1. The device 100 can be described as an electrical control unit (ECU). The electric motor 300 comprises a position monitoring device 302. The position monitoring device 302 comprises a first Hall sensor that provides a first signal, a second Hall sensor that provides a second signal and a third Hall sensor that provides a third signal. The Hall sensors each provide a binary signal, wherein a first signal value indicates that a magnetic flux at a Hall sensor is less than a threshold value, and a second signal value indicates that the magnetic flux at the Hall sensor is greater than the threshold value. The position monitoring device 302 is connected by way of lines 304 to the device 100. The position monitoring device 302 is supplied with a supply voltage (Vcc) by way of a supply line 306, which supply voltage uses line 308 as a ground line. A first signal line 310 connects the first Hall sensor to the device 100 in order to transmit the first signal, a second signal line 312 connects the second Hall sensor to the device 100 in order to transmit the second signal and a third signal line 314 connects the third Hall sensor to the device 100 in order to transmit the third signal. The signal lines 310, 312, 314 are connected to the device unit 102 for determining an average value of the three signals. The device unit 102 for the determining step comprises a first resistor 316 that is connected between the first signal line 310 and a central point, a second resistor 318 that is connected between the second signal line 312 and the central point, and a third resistor 320 that is connected between the third signal line 314 and the central point. In this exemplary embodiment, the first resistor 316 is identical to the second resistor 318 and identical to the third resistor 320. The average value is obtained at the central point by summating the signals. The central point is connected to the device unit 104 for the comparing step and provides the average value as an analog signal for the device unit 104 for the comparing step. The device unit 104 for the comparing step is a component of a processor 322 (CPU) in this case. The processor 322 is additionally connected directly to the signal lines 310, 312, 314. The processor 322 is embodied for the purpose of determining a position of the magnetic field in the electric motor 300 on the basis of a characteristic signal pattern of the three signals on the signal lines 310, 312, 314. The device unit 104 for the comparing step is embodied for the purpose of comparing the average value with an expected temporal progression of the average value. The expected progression is stored in the device 100 for monitoring signal levels. If the average value deviates from the progression by more than a tolerance range, the device unit 104 for the comparing step provides an error message.

FIG. 4 is a representation of signals 400 from Hall sensors and a resulting average value 402 in accordance with an exemplary embodiment of the present disclosure. The figure illustrates three binary signals 400 that comprise a phase displacement of 120° with respect to one another. A complete cycle of one of the signals 400 represents a complete rotation of a magnetic field of an electric motor. The signals 400 are output signals of three Hall sensors that detect the magnetic field and said signals are provided by way of three signal lines, as illustrated in FIG. 3. The signals 400 are illustrated one above the other in a temporally correlated manner. In a first range 404, the signals 400 comprise a regular progression without malfunctions. In a second range 406, at least one of the signals 400 in each case comprises a malfunction. The average value 402 is illustrated below the signals 400. The average value 402 is allocated to the signals 400 in a temporally correlated manner. A time value is arranged one above the other in all the illustrations. The time value also directly indicates an angular position of the magnetic field in the electric motor. The signals 400 comprise in each case a high voltage value and a low voltage value. The high voltage value corresponds to a supply voltage of the Hall sensors. The low voltage value comprises a ground potential. The signals 400 change periodically between the high voltage value and the low voltage value. The average value 402 can comprise as a minimum value the ground potential. As a maximum, the average value 402 can comprise a voltage that is combined from all three signals. However, as a result of the signals 400 having a phase displacement of 120° with respect to one another, always at least one of the signals 400 comprises the high voltage value and one of the signals 400 comprises the low voltage value. As a consequence, the average value 402 changes in the first region 404 every 60° between a first value 408 of a third of the maximum value and a second value 410 of two thirds of the maximum value. In the case of a transition between the values 408, 410, the average value 402 approaches the target value in an asymptotic manner in each case without overshooting. A short time period passes until the target value is achieved in a stable manner. During the transition, the average value 402 traverses a transition range 412 extremely rapidly, which transition range 412 is not allocated to any state. As long as the average value 402 traverses the transition range 412 within a predetermined time period and subsequently within a first tolerance range around the first value 408 or within a second tolerance range around the second value 410, the device unit for the comparing step does not provide an error message. Consequently, the tolerance ranges can occur in a static manner and the transition range 412 can only occur in a dynamic manner. A first blocking region that lies between the first tolerance range and the ground potential is not allowed, neither is a second blocking region that lies between the second tolerance range and the maximum value.

Different malfunctions in the signals 400 are illustrated in the second range 406. By way of example, a line defect 414 is illustrated in the second signal. The line defect 414 causes the second signal to fall prematurely from the high voltage value to the low voltage value, whereas the first signal and the second signal are undisturbed. The line defect 414 causes the average value 402 to fall from the second value 410 to the first value 408. Since the line is interrupted, the average value 402 traverses the transition range 412 at a sufficiently rapid rate and said average value comprises subsequently the first value 408. Consequently, the average value 402 fulfills the expected criteria and an error message is not provided. Once the magnetic field in the electric motor has deviated by 60°, the first signal falls as intended from the high voltage value to the low voltage value. The average value 402 therefore falls from the first value 408 to the ground potential and consequently into the first blocking region. At this point, the average value is outside the expected criteria and a first error message 416 is provided. It is clearly evident from the error message 416 that the malfunction relates to the second signal.

Subsequently, the figure illustrates by way of example a voltage drop 418 in the supply voltage at all the sensors. As a result of the voltage drop 418, the signals 400 in each case are no longer able to achieve the high voltage value. The low voltage value is maintained in the illustrated malfunction event. Since the average value 402 is formed by summating the three signals 400 whilst utilizing the resistors, illustrated in FIG. 3, the average value 402 falls overall to a lower value than previously. However, since the first value 408 and the second value 410 and also the transition range 412 are stored with absolute values in the device unit for the comparing step, a second error message 420 is provided as soon as the average value 402 remains longer than the predefined time period outside the first tolerance range and outside the second tolerance range. The error message 420 can mention that the voltage drop 418 is the cause of the malfunction so that a cause of the malfunction can be purposefully eliminated.

For the purpose of monitoring Hall sensor signals 400 in particular in EC motors, three Hall sensor signals 400 that are to be monitored are combined by way of a diode network and conclusions relating to the Hall sensor supply voltage are drawn on the basis of measuring the resulting voltage. The Hall sensor signals 400 can be monitored using the disclosed method without having to use diodes. It is not the maximum voltage of the three Hall signals 400 that is determined but rather an arithmetic average value 402 is determined. The evaluation can be performed by means of a hardware device, as illustrated in FIG. 3, but can also be performed by means of a software function in a microcontroller.

Since a non-statically allowed voltage range 412 is traversed for a short period of time during the transition from a statically allowed voltage value 408 to the other statically allowed voltage value 410, an evaluating device can detect this transition state and allow said transition state for a short period of time without triggering an error message. In the hardware version, this can be achieved by means of a downstream filter function. Alternatively, a software function can implement the filtering process.

The exemplary embodiments that are described and illustrated in the figures are selected only as examples. Different exemplary embodiments can be stand-alone or can be combined with one another in relation to individual features. An exemplary embodiment can also be supplemented by means of features of a further exemplary embodiment.

Moreover, method steps in accordance with the disclosure can be repeated and can be performed in a sequence that differs from the described sequence.

One exemplary embodiment comprises an “and/or”—combination between a first feature and a second feature, in other words, the exemplary embodiment in accordance with an embodiment comprises both the first feature and also the second feature and in accordance with a further embodiment comprises either only the first feature or only the second feature.

What is claimed is:

1. A method for monitoring signal levels of signals that are generated, for the purpose of detecting a magnetic field, by a plurality of Hall sensors, comprising:
determining an average value of the signal levels; and
comparing a progression of the average value with an expected progression of the average value,
wherein the expected progression includes a characteristic temporal sequence of a first value and at least a second value that differs from the first value, and
wherein an error message is provided if the average value deviates from the expected progression by more than a tolerance range.

2. The method according to claim 1, wherein the error message is provided in the comparing step if the average value dwells longer than a predetermined transition time outside a first tolerance range around the first value or outside a second tolerance range around the second value.

3. The method according to claim 2, wherein:
the error message is provided in the comparing step if the average value dwells longer than the transition time outside the first tolerance range or outside the second tolerance range or at least outside an additional tolerance range, and
the additional tolerance range is arranged adjacent to the first tolerance range and/or the second tolerance range.

4. The method according to claim 3, wherein:
the error message includes additional information in the comparing step, and
the additional information indicates from which tolerance range the average value deviates and/or whether the average value subsequently dwells at a rising signal edge or subsequently dwells at a falling signal edge.

5. The method according to claim 1, wherein:
position information regarding the magnetic field that is monitored by the Hall sensors is obtained in the comparing step from the average value, and
the position information is determined from a correlation between an actual signal level of the average value and an angular position of the magnetic field.

6. The method according to claim 1, wherein the average value is determined in the determining step from a first signal level, a second signal level, and a third signal level.

7. The method according to claim 6, wherein the average value is moreover determined in the determining step from at least an additional signal level.

8. A device for monitoring signal levels of signals that are generated, for the purpose of detecting a magnetic field, by a plurality of Hall sensors, comprising:
a first device unit configured to determine an average value of the signal levels; and
a second device unit configured to compare a progression of the average value with an expected progression of the average value,
wherein the expected progression comprises a characteristic temporal sequence of a first value and at least a second value that differs from the first value, and
wherein the second device unit is further configured to provide an error message if the average value deviates from the expected progression by more than a tolerance range.

9. A computer program product comprising:
a program code configured to perform a method for monitoring signal levels of signals that are generated, for the purpose of detecting a magnetic field, by a plurality of Hall sensors, if the program product is implemented on a device, the method including
determining an average value of the signal levels, and
comparing a progression of the average value with an expected progression of the average value,
wherein the expected progression includes a characteristic temporal sequence of a first value and at least a second value that differs from the first value, and
wherein an error message is provided if the average value deviates from the expected progression by more than a tolerance range.
